(19) United States
(12) Patent Application Publication
(10) Pub. No.: US 2015/0376371 A1
(43) Pub. Date: Dec. 31, 2015

(54) ULTRASONIC SENSOR ASSEMBLY FOR VEHICLE AND METHOD FOR MANUFACTURING RUBBER OF ULTRASONIC SENSOR ASSEMBLY

(71) Applicant: HYUNDAI MOBIS Co., Ltd, Seoul (KR)

(72) Inventor: Sang Hee BAE, Yongin-si (KR)

(73) Assignee: HYUNDAI MOBIS CO., LTD, Seoul (KR)

(21) Appl. No.: 14/738,172

(22) Filed: Jun. 12, 2015

(30) Foreign Application Priority Data
Jun. 25, 2014 (KR) 10-2014-0078135

(51) Int. Cl. C08K 3/36; G01V 1/00

(52) U.S. Cl. CPC C08K 3/36; G01V 1/001

(57) ABSTRACT

Provided is an ultrasonic sensor assembly for a vehicle. The ultrasonic sensor assembly is characterized by including a hollow housing, a rubber which couples a sensor cell to the housing, and a potting liquid with which the interior of the housing is filled, in which the rubber is made of fumed silica.

### CROSS-REFERENCE TO RELATED APPLICATIONS

This application claims priority under 35 U.S.C. §119 to Korean Patent Application No.10-2014-0078135, filed on Jun. 25, 2014, in the Korean Intellectual Property Office, the disclosure of which is incorporated herein by reference in its entirety.

### TECHNICAL FIELD

The present invention relates to an ultrasonic sensor assembly for a vehicle and a method for manufacturing a rubber of the sensor assembly for a vehicle, and more particularly, to an ultrasonic sensor assembly for a vehicle having a rubber and a method for manufacturing the rubber.

### BACKGROUND

An ultrasonic sensor, which is installed in a vehicle, is utilized for the purpose of sensing an object placed at the rear of the vehicle or an object in a blind spot.

A general ultrasonic sensor for a vehicle broadly includes components such as a sensor cell, a rubber, a housing, and a potting member having a potting liquid.

Among the components, the rubber is made of silicone, and in a case in which an ultrasonic sensor assembly for a vehicle is installed on a bumper of the vehicle, the rubber serves to attenuate external vibration that is generated in the bumper and transmitted to the sensor cell.

Meanwhile, the ultrasonic sensor for a vehicle is installed on the vehicle bumper so that a surface of the sensor cell and an upper end surface of the rubber, which surrounds the surface of the sensor cell, are exposed to the outside.

Because the rubber is a component that is made of silicone and exposed to the outside, the rubber becomes discolored, and particularly, the rubber is more likely to be discolored in a hot and humid environment.

During a process of assembling the ultrasonic sensor for a vehicle, the rubber is assembled to be adjacent to the potting liquid, and in this case, an antioxidant, which constitutes the potting liquid, chemically reacts with the silicone that constitutes the rubber, which causes discoloration of the rubber.

As described above, since the silicone is a major ingredient of the rubber and the silicone chemically reacts with the antioxidant, which constitutes the potting liquid member, in a hot and humid environment, there is a problem in that the upper end surface of the rubber is excessively discolored. In particular, in a case in which the vehicle is transported on a cargo ship by sea, the rubber is likely to be discolored due to a hot and humid environment in a container box.

### SUMMARY

An exemplary embodiment of the present invention provides an ultrasonic sensor assembly for a vehicle, including: a hollow housing; a rubber which couples a sensor cell to the housing; and a potting liquid member with which the interior of the housing is filled, in which a major substance of the rubber is fumed silica.

Another exemplary embodiment of the present invention provides a method for manufacturing a rubber for an ultrasonic sensor assembly for a vehicle, the method including: preparing fumed silica; preparing a cross-linker; and mixing the fumed silica and the cross-linker.

Other features and aspects will be apparent from the following detailed description, the drawings, and the claims.

### BRIEF DESCRIPTION OF THE DRAWINGS

FIGS. 1 to 3 are views illustrating an ultrasonic sensor assembly for a vehicle according to an exemplary embodiment of the present invention.

FIG. 4 is a view for explaining a discoloration mechanism of a rubber that constitutes an ultrasonic sensor assembly for a vehicle in the related art.

FIGS. 5 and 6 are graphs illustrating results of testing performance of the ultrasonic sensor assembly for a vehicle having a rubber according to the exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, a sensor assembly for a vehicle according to an exemplary embodiment of the present invention will be described in detail with reference to the accompanying drawings.

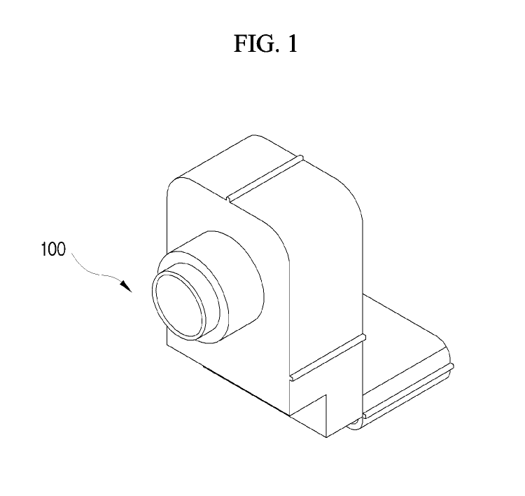

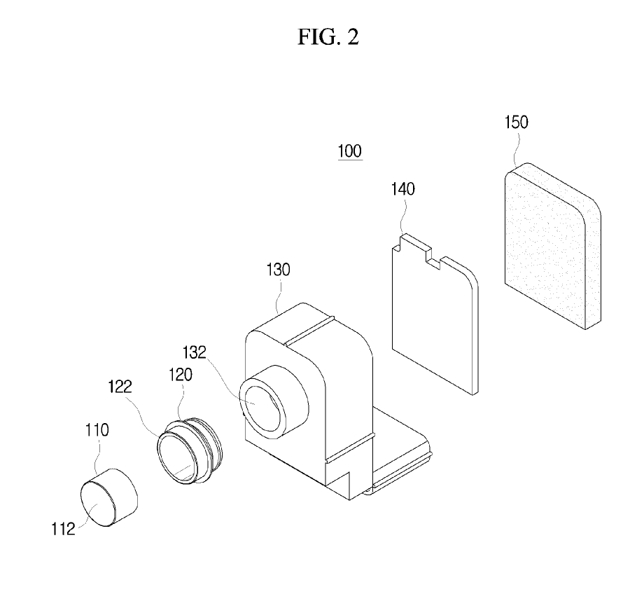

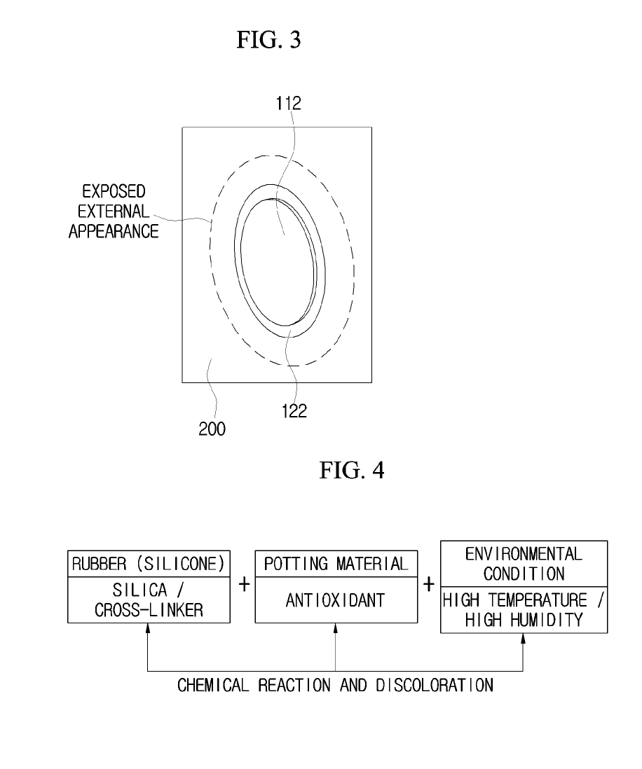

FIGS. 1 to 3 are views illustrating an ultrasonic sensor assembly for a vehicle according to the exemplary embodiment of the present invention, in which FIG. 1 is a perspective view illustrating an external appearance of the ultrasonic sensor assembly for a vehicle, and FIG. 2 is an exploded perspective view of the ultrasonic sensor assembly illustrated in FIG. 1. Further, FIG. 3 is a view illustrating a state in which the ultrasonic sensor assembly illustrated in FIG. 1 is mounted on a vehicle bumper.

Referring to FIGS. 1 to 3, an ultrasonic sensor assembly 100 according to an exemplary embodiment of the present invention includes a sensor cell 110, a rubber (a rubber cap) 120, a housing 130, a printed circuit board (PCB) 140, and a potting liquid member (a potting material) 150.

The sensor cell 110 is an ultrasonic sensor capable of generating and receiving ultrasonic waves, and may be formed in a cylindrical shape so as to be inserted into an accommodating groove 132 in the housing 130 in a state in which the sensor cell 110 is coupled to the rubber 120.

The rubber 120 is a member that couples the sensor cell 110 to the housing 130, and serves to block vibration of a vehicle bumper 200 from being transmitted to the sensor cell 110.

As illustrated in FIG. 3, an upper end surface 122 of the rubber 120 surrounds a surface 112 of the sensor cell 110, and the rubber 120 is installed on the vehicle bumper 200 so that the upper end surface 122 of the rubber 120 and the surface 112 of the sensor cell 110 are exposed to the outside.

The silicone, which constitutes a material of the rubber 120, broadly includes a polymer, and a cross-linker.

As illustrated in the following Table 1, in the case of the rubber 120 according to the exemplary embodiment of the present invention, a polymer, which contains fumed silica as a major ingredient, replaces a polymer in the related art which contains precipitated silica as a major ingredient.

As the cross-linker, a platinum catalyst is used instead of peroxide of the cross-linker in the related art.

As other substances, a yellowing inhibitor (or a composition for preventing yellowing), which impedes discoloration of the rubber, may be used, and aromatic polyurethane is used as the yellowing inhibitor.

TABLE 1

| | | | Exemplary Embodiment of |
|---|---|---|---|
| Classification | Content | Related Art | Present Invention |
| Polymer | 97.6 | Precipitated | Fumed Silica |
| | | Silica | |
| Cross-linker | 2.0 | Peroxide | Platinum Catalyst |
| Other | 0.4 | — | Aromatic Polyurethane |
| Substances | | | |

As illustrated in FIG. 4, the silicone in the related art is discolored through the discoloration mechanism in which the silicone chemically reacts with the antioxidant that constitutes the potting liquid member 150 under a hot and humid environmental condition. In particular, because the precipitated silica in the related art contains moisture, has a wider molecular structure, and generates a large number of by-products, a rate of the occurrence of discoloration is high.

Therefore, in the exemplary embodiment of the present invention, the polymer, which contains fumed silica as a major ingredient, is used in order to solve the problem of discoloration of the rubber 120.

The fumed silica contains nearly no moisture, has a narrow molecular structure, and does not generate a by-product, and as a result, a rate of the occurrence of discoloration is low.

The cross-linker is a substance that serves to harden the fumed silica, and in the exemplary embodiment of the present invention, as illustrated in Table 1, the platinum catalyst is used as the cross-linker instead of the peroxide in the related art. The platinum catalyst minimizes the occurrence of the by-product during hardening.

Next, the housing 130 has a hollow shape so as to accommodate the rubber 120 that contains the fumed silica as a major ingredient, and the housing 130 accommodates the sensor cell 110 and various types of components.

Although not illustrated, a terminal pin, which is electrically connected with the PCB 140, is provided on the housing 130. The terminal pin is fixed to the PCB 140 by soldering and electrically connected with the PCB 140.

The PCB 140 is inserted into the housing 130, and the interior of the housing 100 is then filled with the potting liquid 150, and as a result, the interior of the housing 130 is sealed.

The potting liquid member 150 is made of butadiene or urethane, and hardened in a state in which the potting liquid member 150 is injected into an internal space of the housing 130, such that the internal space of the housing 130 is filled with the potting liquid member 150.

Therefore, various types of components inserted into the housing 130 may be protected from external impact or sway, and also protected from foreign substances flowing in from the outside of the housing 130, thereby improving a lifespan of the ultrasonic sensor assembly.

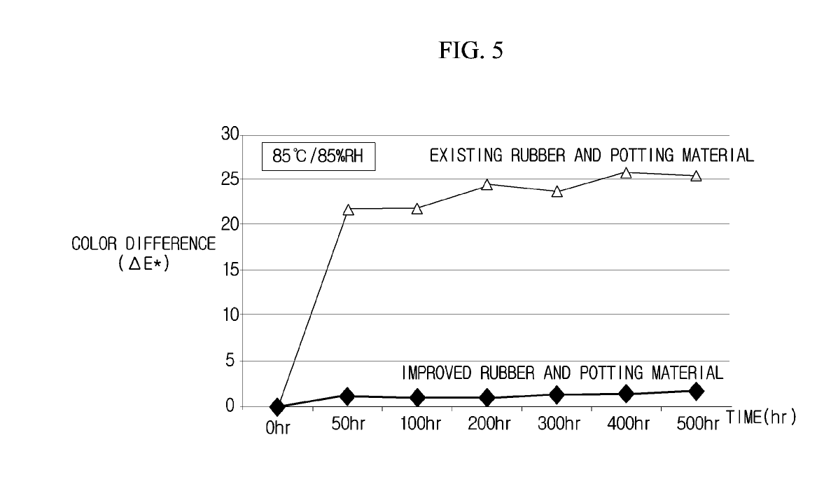

FIG. 5 is a graph illustrating before and after a discoloration test of the rubber according to the exemplary embodiment of the present invention is carried out in a hot and humid environment.

As illustrated in FIG. 5, it can be seen that a color difference value ΔE*, which shows a degree at which the rubber according to the exemplary embodiment of the present invention, which includes improved rubber (fumed silica) and a potting material, is discolored, is eight times lower than that of the rubber in the related art that includes the existing rubber (precipitated silica) and a potting material.

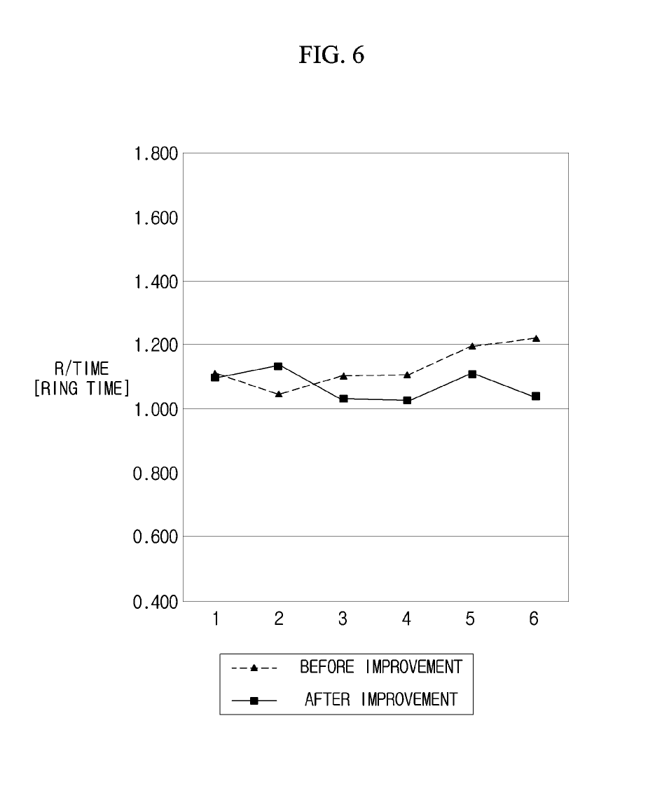

FIG. 6 is a graph illustrating a result of testing performance of the ultrasonic sensor having the rubber according to the exemplary embodiment of the present invention.

In the graph illustrated in FIG. 6, a horizontal axis indicates time, and a vertical axis indicates ring time.

There exists a ring time for the ultrasonic sensor, and the ring time refers to time with respect to residual vibration after vibration of the sensor cell. The ring time is an important factor in terms of frequency properties.

As illustrated in the graph in FIG. 6, it can be seen that there is no great difference between the ring time of the ultrasonic sensor with the rubber after being improved and the ring time of the ultrasonic sensor with the rubber before being improved. This is the result showing that the ultrasonic sensor with the rubber improved according to the exemplary embodiment of the present invention has the same performance as the ultrasonic sensor in the related art.

According to the present invention, the rubber, which constitutes the ultrasonic sensor assembly for a vehicle, contains the fumed silica as a major ingredient, thereby preventing the rubber from being discolored in a hot and humid environment, and improving quality of the ultrasonic sensor for a vehicle.

From the aforementioned description, it may be understood by a person skilled in the art that the present invention may be carried out in other specific forms without changing the technical spirit or the essential characteristics. Thus, it should be appreciated that the exemplary embodiments described above are intended to be illustrative in every sense, and not restrictive. The scope of the present invention is represented by the claims to be described below rather than the detailed description, and it should be interpreted that all the changes or modified forms, which are derived from the scope of the claims, and the equivalents thereto, are included in the scope of the present invention.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An ultrasonic sensor assembly for a vehicle, comprising:
a hollow housing;
a rubber which couples a sensor cell to the housing; and
a potting liquid member with which the interior of the housing is filled,
wherein a major substance of the rubber is fumed silica.

2. The ultrasonic sensor assembly of claim 1, wherein the rubber includes:
a polymer which contains the fumed silica as a major ingredient; and
a cross-linker which contains a platinum catalyst, which hardens the fumed silica, as a major ingredient.

3. The ultrasonic sensor assembly of claim 1, wherein the rubber includes the fumed silica of 97.6 wt %, a platinum catalyst of 2.0 wt %, and other substances of 0.4 wt %.

4. The ultrasonic sensor assembly of claim 1, wherein the fumed silica serves to inhibit discoloration of the rubber due to a chemical reaction with the potting liquid member in a hot and humid environment.

5. A method for manufacturing a rubber of an ultrasonic sensor assembly that includes a hollow housing, a rubber which couples a sensor cell to the housing, and a potting liquid with which the interior of the housing is filled, the method comprising:
preparing fumed silica;
preparing a cross-linker; and
mixing the fumed silica and the cross-linker.

6. The method of claim 5, wherein the cross-linker is a platinum catalyst.

7. The method of claim 5, wherein the rubber includes the fumed silica of 97.6 wt %, a platinum catalyst of 2.0 wt %, and other substances of 0.4 wt %.

8. The method of claim 5, wherein the fumed silica serves to inhibit discoloration of the rubber due to a chemical reaction with the potting liquid member in a hot and humid environment.
